(19) United States
(12) Patent Application Publication
(10) Pub. No.: US 2019/0057272 A1
(43) Pub. Date: Feb. 21, 2019

(54) METHOD OF DETECTING A SNOW COVERED ROAD SURFACE

(71) Applicant: GM GLOBAL TECHNOLOGY OPERATIONS LLC, Detroit, MI (US)

(72) Inventors: Qingrong Zhao, Madison Heights, MI (US); Bakhtiar B. Litkouhi, Washington, MI (US); Qi Zhang, Sterling Heights, MI (US); Jinsong Wang, Troy, MI (US); Wende Zhang, Troy, MI (US); Jingfu Jin, Troy, MI (US)

(73) Assignee: GM GLOBAL TECHNOLOGY OPERATIONS LLC, Detroit, MI (US)

(21) Appl. No.: 15/681,008

(22) Filed: Aug. 18, 2017

(51) Int. Cl. G06K 9/32; G06T 7/11; G06T 7/174; G06K 9/00; G06K 9/46; G06T 7/41

(52) U.S. Cl. CPC G06K 9/3233; G06T 7/11; G06T 7/174; G06T 2207/30252; G06K 9/4661; G06T 7/41; G06K 9/00791

(57) ABSTRACT

A method of identifying a snow covered road includes creating a forward image of a road surface. The forward image is analyzed to detect a tire track in the forward image. When a tire track is detected in the forward image, a message indicating a snow covered road surface is signaled. When a tire track is not detected in the forward image, a rearward image, a left side image, and a right side image are created. The rearward image, the left side image, and the right side image are analyzed to detect a tire track in at least one of the rearward image, the right side image, and the left side image. A message indicating a snow covered road surface is signaled when a tire track is detected in one of the rearward image, the left side image, or the right side image.

### INTRODUCTION

The disclosure generally relates to a method of identifying a snow covered road surface.

Vehicle control systems may use the condition of the road surface as an input for controlling one or more components of the vehicle. Differing conditions of the road surface affect the coefficient of friction between the tires and the road surface. Dry road surface conditions provide a high coefficient of friction, whereas snow covered road conditions provide a lower coefficient of friction. Vehicle controllers may control or operate the vehicle differently for the different conditions of the road surface. It is therefore desirable for the vehicle to be able to determine the current condition of the road surface.

### SUMMARY

A method of identifying a snow covered road surface is provided. The method includes creating a forward image with a forward camera. The forward image is an image of the road surface in a forward region relative to a body of a vehicle. A computing unit analyzes the forward image to detect a tire track in the forward image. When a tire track is not detected in the forward image, the computing unit creates a rearward image with a rearward camera. The rearward image is an image of the road surface in a rearward region relative to the body of the vehicle. The computer unit analyzes the rearward image to detect a tire track in the rearward image, and signals a message indicating the road surface may be covered with snow when a tire track is detected in the rearward image.

In one aspect of the method, the computing unit signals a message indicating the road surface may be covered with snow when a tire track is detected in the forward image.

In one aspect of the method, when a tire track is not detected in the forward image, the computing unit creates at least one of a left side image with a left side camera, or a right side image with a right side camera. The left side image is an image of the road surface in a left side region relative to the body of the vehicle. The right side image is an image of the road surface of a right side region relative to the body of the vehicle.

In another aspect of the method, the computing unit analyzes at least one of the left side image and the right side image to detect a tire track in at least one of the left side image and the right side image. In one embodiment of the method, when the vehicle is traveling along a linear path, the computing unit analyzes both the left side image and the right side image to detect a tire track in at least one of the left side image and the right side image. In another embodiment, when the vehicle is traveling along a curved path to the right side of the vehicle, the computing unit analyzes the left side image to detect a tire track in the left side image. In another embodiment of the method, when the vehicle is traveling along a curved path to the left side of the vehicle, the computing unit analyzes the right side image to detect a tire track in the right side image.

In another aspect of the method, the computing unit signals the message indicating the road surface may be covered with snow when a tire track is detected in at least one of the rearward image, the left side image, or the right side image.

In one another aspect of the method, analyzing each of the forward image, the rearward image, the left side image, and the right side image includes extracting a respective region of interest from each of the forward image, the rearward image, the left side image, and the right side image. In one embodiment of the method, the respective region of interest of each of the forward image, the rearward image, the left side image, and the right side image is dependent upon a current steering angle of the vehicle.

In one embodiment of the method, analyzing each respective one of the forward image, the rearward image, the left side image, and the right side image to detect a tire track therein includes a respective line analysis to detect one or more lines and/or a line pattern in the forward image, the rearward image, the left side image, and the right side image. In another embodiment of the method, analyzing each respective one of the forward image, the rearward image, the left side image, and the right side image to detect a tire track therein includes a respective statistical analysis to detect directional texture dependency and complexity in the forward image, the rearward image, the left side image, and the right side image. In another embodiment of the method, analyzing each respective one of the forward image, the rearward image, the left side image, and the right side image includes analyzing at least one of the forward image, the rearward image, the left side image or the right side image using a brightness analysis to detect contrast or a brightness level of the road surface. A higher brightness level is indicative of a snow-covered road surface, whereas as darker or lower brightness level is indicative of a non-snow-covered road surface.

A vehicle is also provided. The vehicle includes a body, a forward camera, a rearward camera, a left side camera, and a right side camera. The forward camera is attached to the body and is positioned to create an image of a road surface in a forward region relative to the body. The rearward camera is attached to the body and is positioned to create an image of the road surface in a rearward region relative to the body. The left side camera is attached to the body and is positioned to create an image of the road surface along a left side of the body. The right side camera is attached to the body and is positioned to create an image of the road surface along a right side of the body. A computing unit is disposed in communication with the forward camera, the rearward camera, the left side camera, and the right side camera. The computing unit includes a processor and a memory having a road surface snow detection algorithm saved thereon. The processor is operable to execute the road surface snow detection algorithm to create a forward image of a road surface in the forward region with the forward camera. The computing unit analyzes the forward image to detect a tire track in the forward image, and signals a message indicating the road surface may be covered with snow when a tire track is detected in the forward image. When a tire track is not detected in the forward image, the computing unit creates a rearward image of the road surface in the rearward region with the rearward camera, and analyzes the rearward image to detect a tire track in the rearward image. When a tire track is detected in the rearward image, the computing unit signals a message indicating the road surface may be covered with snow.

In another aspect of the vehicle, when a tire track is not detected in the forward image, the processor is operable to execute the road surface snow detection algorithm to create at least one of a left side image with the left side camera, and a right side image with the right side camera. The left side image is an image of the road surface in the left side region relative to the body of the vehicle. The right side image is an image of the road surface in the right side region relative to the body of the vehicle.

In another aspect of the vehicle, the processor is operable to execute the road surface snow detection algorithm to analyze at least one of the left side image and the right side image to detect a tire track in at least one of the left side image and the right side image. In one embodiment, when the vehicle is traveling along a linear path, analyzing at least one of the left side image and the right side image includes analyzing both the left side image and the right side image to detect a tire track in at least one of the left side image and the right side image. In another embodiment, when the vehicle is traveling along a curved path to the right side of the vehicle, analyzing at least one of the left side image and the right side image includes analyzing the left side image to detect a tire track in the left side image. In another embodiment, when the vehicle is traveling along a curved path to the left side of the vehicle, analyzing at least one of the left side image and the right side image includes analyzing the right side image to detect a tire track in the right side image.

In another aspect of the vehicle, analyzing each of the forward image, the rearward image, the left side image, and the right side image includes extracting a respective region of interest from each of the forward image, the rearward image, the left side image, and the right side image. In one embodiment, the respective region of interest of each of the forward image, the rearward image, the left side image, and the right side image is dependent upon a current steering angle of the vehicle.

In another aspect of the vehicle, the processor is operable to execute the road surface snow detection algorithm to signal the message indicating the road surface may be covered with snow when a tire track is detected in at least one of the forward image, the rearward image, the left side image, or the right side image.

A method of identifying a snow covered road surface is also provided. The method includes creating an image of a road surface with a camera. A computing unit analyzes the image using a line analysis algorithm, to detect one or more lines and/or a line pattern in the image. The computing unit analyzes the image using a statistical analysis algorithm, to detect directional texture dependency and complexity in the image. The computing unit analyzes the image using a brightness analyses algorithm, to detect contrast or a brightness level in the image. The computing unit then examines the results of the line analysis, the statistical analysis, and the brightness analysis to determine if the road surface is covered with snow or if the road surface is not covered with snow.

In circumstances in which the road surface is covered with a layer of snow that has not previously before been driven on, the road surface in the front region, forward of the vehicle, will not have tire tracks that may be identified to indicate that the road surface is covered in snow. However, along the left side region, the right side region, and/or the rearward region, the tires of the vehicle will have left tire tracks in the snow that will be visible. Accordingly, when no tire tracks are present in the forward region of the vehicle, the computing unit may identify a snow covered road by examining the left side image, the right side image and/or the rearward image, by detecting the tire tracks left by the vehicle in the left side region, the right side region and/or the rearward region.

In order to identify if a feature of the forward image, the rearward image, the left side image and/or the right side image is a tire track, the computing unit may analyze the feature with a line analysis algorithm, a statistical analysis, and a brightness analyses, and use the results of each to determine if the feature is a tire track.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic plan view of a vehicle traveling along a linear path.

FIG. 2 is a schematic plan view of the vehicle traveling along a curved path toward the left side of the vehicle.

FIG. 3 is a schematic plan view of the vehicle traveling along a curved path toward the right side of the vehicle.

FIG. 4 is a flowchart representing a method of identifying a snow covered road surface.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Referring to the FIGS., wherein like numerals indicate like parts throughout the several views, a vehicle is generally shown at 20. As used herein, the term “vehicle” is not limited to automobiles, and may include a form of moveable platform, such as but not limited to, trucks, cars, tractors, motorcycles, atv's, etc. While this disclosure is described in connection with an automobile, the disclosure is not limited to automobiles.

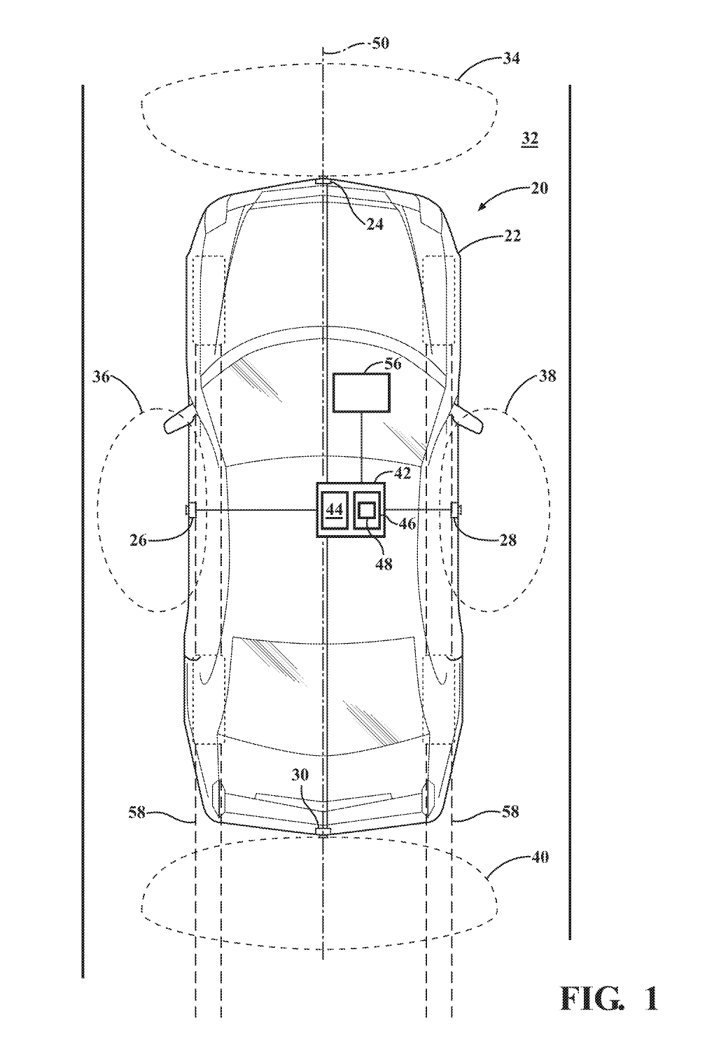

Referring to FIGS. 1 through 3, the vehicle 20 includes a body 22. As used herein, the “body” should be interpreted broadly to include, but is not limited to, all frame and exterior panel components of the vehicle 20. The body 22 may be configured in a suitable manner for the intended purpose of the vehicle 20. The specific type, style, size, shape, etc. of the body 22 are not pertinent to the teachings of this disclosure, and are therefore not described in detail herein.

The vehicle 20 includes a plurality of cameras. As shown in FIGS. 1 through 3, the vehicle 20 includes a forward camera 24, a left side camera 26, a right side camera 28, and a rearward camera 30. However, it should be appreciated that the vehicle 20 may include more or less than the exemplary four cameras shown in FIGS. 1 through 3 and described herein.

Referring to FIGS. 1 through 3, the forward camera 24 is attached to the body 22, and is positioned to create an image of a road surface 32 in a forward region 34 relative to the body 22 of the vehicle 20. The forward camera 24 may include a device suitable for use with image recognition applications, and that is capable of capturing or creating an electronic image, and communicating and/or saving the image to a memory storage device. The specific type, construction, operation, etc. of the forward camera 24 is not pertinent to the teachings of this disclosure, and are therefore not described in detail herein. The forward camera 24 may include a light source (not shown) positioned to illuminate the road surface 32 in the forward region 34. The light source may include a light producing device, such as but not limited to a light emitting diode (LED), a flash, a laser, etc.

The forward camera 24 is shown in the exemplary embodiment attached to a front bumper of the vehicle 20, with the forward region 34 being directly ahead of the front bumper. As such, the forward camera 24 is operable to capture or create an image of the road surface 32 in the forward region 34. It should be appreciated that the forward camera 24 may be positioned at some other location on the body 22 of the vehicle 20.

Referring to FIGS. 1 through 3, the left side camera 26 is attached to the body 22, and is positioned to create an image of the road surface 32 in a left side region 36 relative to the body 22. The left side camera 26 may include a device suitable for use with image recognition applications, and that is capable of capturing or creating an electronic image, and communicating and/or saving the image to a memory storage device. The specific type, construction, operation, etc. of the left side camera 26 is not pertinent to the teachings of this disclosure, and are therefore not described in detail herein.

The left side camera 26 is shown in the exemplary embodiment attached to a left side floor pan of the vehicle 20, with the left side region 36 being just outboard and below the left side of the vehicle 20. The left side camera 26 may include a light source (not shown) positioned to illuminate the road surface 32 in the left side region 36. The light source may include a light producing device, such as but not limited to a light emitting diode (LED), a flash, a laser, etc. It should be appreciated that the left side camera 26 may be located at different locations relative to the body 22 in order to capture an image of the left side region 36.

Referring to FIGS. 1 through 3, the right side camera 28 is attached to the body 22, and is positioned to create an image of the road surface 32 in a right side region 38 relative to the body 22. The right side camera 28 may include a device suitable for use with image recognition applications, and that is capable of capturing or creating an electronic image, and communicating and/or saving the image to a memory storage device. The specific type, construction, operation, etc. of the right side camera 28 is not pertinent to the teachings of this disclosure, and are therefore not described in detail herein.

The right side camera 28 is shown in the exemplary embodiment attached to a right side floor pan of the vehicle 20, with the right side region 38 being just outboard and below the right side of the vehicle 20. The right side camera 28 may include a light source (not shown) positioned to illuminate the road surface 32 in the right side region 38. The light source may include a light producing device, such as but not limited to a light emitting diode (LED), a flash, a laser, etc. It should be appreciated that the right side camera 28 may be located at different locations relative to the body 22 in order to capture an image of the right side region 38.

Referring to FIGS. 1 through 3, the rearward camera 30 is attached to the body 22, and is positioned to create an image of the road surface 32 in a rearward region 40 relative to the body 22 of the vehicle 20. The rearward camera 30 may include a device suitable for use with image recognition applications, and that is capable of capturing or creating an electronic image, and communicating and/or saving the image to a memory storage device. The specific type, construction, operation, etc. of the rearward camera 30 is not pertinent to the teachings of this disclosure, and are therefore not described in detail herein. The rearward camera 30 may include a light source (not shown) positioned to illuminate the road surface 32 in the rearward region 40. The light source may include a light producing device, such as but not limited to a light emitting diode (LED), a flash, a laser, etc.

The rearward camera 30 is shown in the exemplary embodiment attached to a rear bumper of the vehicle 20, with the rearward region 40 being directly behind the rear bumper. As such, the rearward camera 30 is operable to capture or create an image of the road surface 32 in the rearward region 40. It should be appreciated that the rearward camera 30 may be positioned at some other location on the body 22 of the vehicle 20.

A computing unit 42 is disposed in communication with the forward camera 24, the left side camera 26, the right side camera 28, and the rearward camera 30. The computing unit 42 may alternatively be referred to as a vehicle controller, a control unit, a computer, a control module, etc. The computing unit 42 includes a processor 44, and a memory 46 having a road surface snow detection algorithm 48 saved thereon. The processor 44 is operable to execute the road surface snow detection algorithm 48 to implement a method of determining if the road surface 32 is covered with snow.

The computing unit 42 is configured to access (e.g., receive directly from the forward camera 24, the left side camera 26, the right side camera 28, and the rearward camera 30, or access a stored version in the memory 46) images generated by the forward camera 24, the left side camera 26, the right side camera 28, and the rearward camera 30 respectively. The processor 44 is operable to control and/or process data (e.g., data of the image).

The processor 44 may include multiple processors, which could include distributed processors or parallel processors in a single machine or multiple machines. The processor 44 could include virtual processor(s). The processor 44 could include a state machine, application specific integrated circuit (ASIC), programmable gate array (PGA) including a Field PGA, or state machine. When the processor 44 executes instructions to perform “operations,” this could include the processor 44 performing the operations directly and/or facilitating, directing, or cooperating with another device or component to perform the operations.

The computing unit 42 may include a variety of computer-readable media, including volatile media, non-volatile media, removable media, and non-removable media. The term “computer-readable media” and variants thereof, as used in the specification and claims, includes storage media and/or the memory 46. Storage media includes volatile and/or non-volatile, removable and/or non-removable media, such as, for example, RAM, ROM, EEPROM, flash memory or other memory technology, CDROM, DVD, or other optical disk storage, magnetic tape, magnetic disk storage, or other magnetic storage devices or other medium that is configured to be used to store information that can be accessed by the computing unit 42.

While the memory 46 is illustrated as residing proximate the processor 44, it should be understood that at least a portion of the memory 46 can be a remotely accessed storage system, for example, a server on a communication network, a remote hard disk drive, a removable storage medium, combinations thereof, and the like. Thus, the data, applications, and/or software described below can be stored within the memory 46 and/or accessed via network connections to other data processing systems (not shown) that may include a local area network (LAN), a metropolitan area network (MAN), or a wide area network (WAN), for example. The memory 46 includes several categories of software and data used in the computing unit 42, including one or more applications, a database, an operating system, and input/output device drivers.

It should be appreciated that the operating system may be an operating system for use with a data processing system. The input/output device drivers may include various routines accessed through the operating system by the applications to communicate with devices, and certain memory components. The applications can be stored in the memory 46 and/or in a firmware (not shown) as executable instructions, and can be executed by the processor 44.

The applications include various programs that, when executed by the processor 44, implement the various features and/or functions of the computing unit 42. The applications include image processing applications described in further detail with respect to the exemplary method of determining if the road surface 32 is covered with snow. The applications are stored in the memory 46 and are configured to be executed by the processor 44.

The applications may use data stored in the database, such as that of characteristics measured by the camera (e.g., received via the input/output data ports). The database includes static and/or dynamic data used by the applications, the operating system, the input/output device drivers and other software programs that may reside in the memory 46.

It should be understood that the description above is intended to provide a brief, general description of a suitable environment in which the various aspects of some embodiments of the present disclosure can be implemented. The terminology “computer-readable media”, “computer-readable storage device”, and variants thereof, as used in the specification and claims, can include storage media. Storage media can include volatile and/or non-volatile, removable and/or non-removable media, such as, for example, RAM, ROM, EEPROM, flash memory 46 or other memory 46 technology, CDROM, DVD, or other optical disk storage, magnetic tape, magnetic disk storage, or other magnetic storage devices or some other medium, excluding propagating signals, that can be used to store information that can be accessed by the computing unit 42.

While the description refers to computer-readable instructions, embodiments of the present disclosure also can be implemented in combination with other program modules and/or as a combination of hardware and software in addition to, or instead of, computer readable instructions.

While the description includes a general context of computer-executable instructions, the present disclosure can also be implemented in combination with other program modules and/or as a combination of hardware and software. The term “application,” or variants thereof, is used expansively herein to include routines, program modules, programs, components, data structures, algorithms, and the like. Applications can be implemented on various system configurations, including single-processor or multiprocessor systems, minicomputers, mainframe computers, personal computers, hand-held computing devices, microprocessor-based, programmable consumer electronics, combinations thereof, and the like.

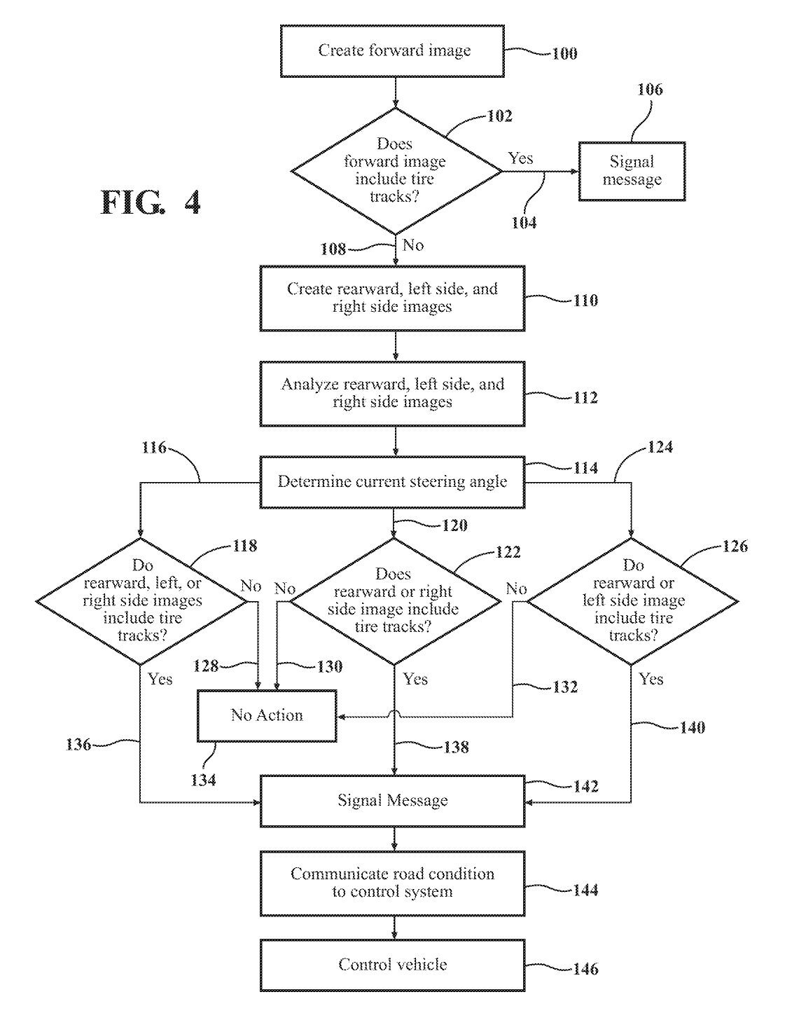

As described above, the memory 46 includes the road surface snow detection algorithm 48 saved thereon, and the processor 44 executes the road surface snow detection algorithm 48 to implement a method of determining if the road surface 32 is covered with snow. Referring to FIG. 4, the method includes creating a forward image of the road surface 32 in the forward region 34 relative to the body 22 of the vehicle 20. The step of creating the forward image is generally indicated by box 100 in FIG. 4. The forward image is created with the forward camera 24, and is communicated to the computing unit 42.

The computing unit 42 analyzes the forward image to detect a tire track 58 in the forward image. The step of analyzing the forward image is generally indicated by box 102 in FIG. 4. The computing unit 42 may use a suitable software, program, algorithm, application, etc., to analyze the forward image. For example, the computing unit 42 may use a directional pattern analysis to identify the presence of tire tracks 58 in the forward image. In other embodiments, the computing unit 42 may use a Canny Filter or Hough transform to detect an edge or line in the forward image that would indicate a tire track 58 in the forward image. It should be appreciated that the computing unit 42 may use other applications to identify the presence of a tire track 58 in the forward image that are not specifically mentioned and/or described herein. Additionally, the specific manner in which the various different applications analyze images to detect features therein are readily understood, and are therefore not described in detail herein.

If the road surface 32 is covered with snow that has not yet been driven over, i.e., is not trampled, such as shown in FIG. 1, then the snow surface covering the road will present a clean surface that does not have edges and/or lines that may be identified as a tire track 58. Accordingly, the computing unit 42 will not detect tire tracks 58, edges, or lines in the forward image when the road surface 32 is covered in snow that is not trampled, i.e., with no tire tracks 58, edges, or lines. As such, analysis of the forward image in this situation may be unable to determine if the road surface 32 is covered in snow. However, if the snow covering the road surface 32 has been previously driven upon, then tire tracks 58, edges, or lines may be visible in the forward image. The identification of the tire tracks 58, edges and/or lines in the forward image is indicated of snow covering the road surface 32, and enables the computing unit 42 to determine that the road surface 32 is covered in snow.

When the computing unit 42 detects or identifies a tire track 58 in the forward image, generally indicated at 104, then the computing unit 42 signals a message indicating the road surface 32 may be covered with snow. The step of signaling the message is generally indicated by box 106 in FIG. 4. The computing unit 42 may signal the message in a desirable manner. For example, the computing unit 42 may display a message to a driver, set a warning code in a vehicle 20 controller, flash an indicator lamp, communicate the message to another vehicle 20 control system 56 such as a stability control system 56, etc. The specific manner in which the message is communicated may vary, and may be dependent upon the specific application.

When the computing unit 42 does not detect or identify a tire track 58 in the forward image, generally indicated at 108, then the road may be covered with snow, or may not be covered with snow. In this situation, when no tire tracks 58 were detected in the forward image, the computing unit 42 then creates a rearward image of the road surface 32, and at least one of a left side image and a right side image of the road surface 32. The step of creating the rearward image, the left side image, and/or the right side image is generally indicated by box 110 in FIG. 4. The rearward image of the road surface 32 is an image of the road surface 32 in the rearward region 40 relative to the body 22 of the vehicle 20. The rearward image is created with the rearward camera 30, and is communicated to the computing unit 42. The left side image of the road surface 32 is an image of the road surface 32 in the left side region 36 relative to the body 22 of the vehicle 20. The left side image is created with the left side camera 26, and is communicated to the computing unit 42. The right side image of the road surface 32 is an image of the road surface 32 in the right side region 38 relative to the body 22 of the vehicle 20. The right side image is created with the right side camera 28, and is communicated to the computing unit 42.

The computing unit 42 then analyzes the rearward image, and at least one of the left side image and the right side image to detect a tire track 58 in at least one of the rearward image, the left side image, and/or the right side image. The step of analyzing the rearward image, the left side image and/or the right side image is generally indicated by box 112 in FIG. 4. The computing unit 42 may use suitable software, program, algorithm, application, etc., to analyze the rearward image, the left side image and/or the right side image. For example, the computing unit 42 may use a directional pattern analysis to identify the presence of tire tracks 58 in the rearward image, the left side image, and/or the right side image. In other embodiments, the computing unit 42 may use a Canny Filter or Hough transform to detect an edge or line in the rearward image, the left side image, and/or the right side image, that would indicate a tire track 58 in one of the respective images. It should be appreciated that the computing unit 42 may use other applications to identify the presence of a tire track 58 in the rearward image, the left side image, and/or the right side image, that are not specifically mentioned and/or described herein. Additionally, the specific manner in which the various different applications analyze images to detect features therein are readily understood, and are therefore not described in detail herein.

Analyzing each of the forward image, the rearward image, the left side image, and/or the right side image may include extracting a respective region of interest from each respective one of the forward image, the rearward image, the left side image, and the right side image. The region of interest is the portion of the respective image that is analyzed to detect a tire track 58 therein. Because vehicles turn, the exact location of the region of interest within the respective images may vary. Accordingly, the respective region of interest of each of the forward image, the rearward image, the left side image, and the right side image may be dependent upon a current steering angle of the vehicle 20.

The computing unit 42 may determine the current steering angle of the vehicle 20. The step of determining the current steering angle of the vehicle 20 is generally indicated by box 114 in FIG. 4. The current steering angle of the vehicle 20 may be determined in a suitable manner, such as by sensing a wheel angle with a position sensor, or querying another vehicle 20 control system 56. It should be appreciated that the current steering angle of the vehicle 20 may be determined in a manner not described herein. The computing unit 42 may determine the current steering angle of the vehicle 20 to be a turn to the left, a turn to the right, or no turn, i.e., movement along a straight linear path 50.

Once the computing unit 42 has determined the current steering angle of the vehicle 20, the computing unit 42 may then isolate the desired region of interest in each respective image, and analyze each respective image to detect a tire track 58 therein. Referring to FIG. 1, when a vehicle 20 is traveling straight ahead along a linear path 50, on a road surface 32 that is covered with un-trampled snow, e.g., fresh snow fall, then the front tires may leave tire tracks 58 in a linear direction directly behind the tires, which should be present in both the left side image and the right side image. Referring to FIG. 4, when the computing unit 42 determines that the vehicle 20 is traveling along the linear path 50, generally indicated at 116 in FIG. 4, then analyzing the rearward image and at least one of the left side image and the right side image may include analyzing the rearward image and both the left side image and the right side image to detect a tire track 58 in at least one of the rearward image, the left side image, and/or the right side image. The step of analyzing the rearward image and both the left side image and the right side image is generally indicated by box 118 in FIG. 4.

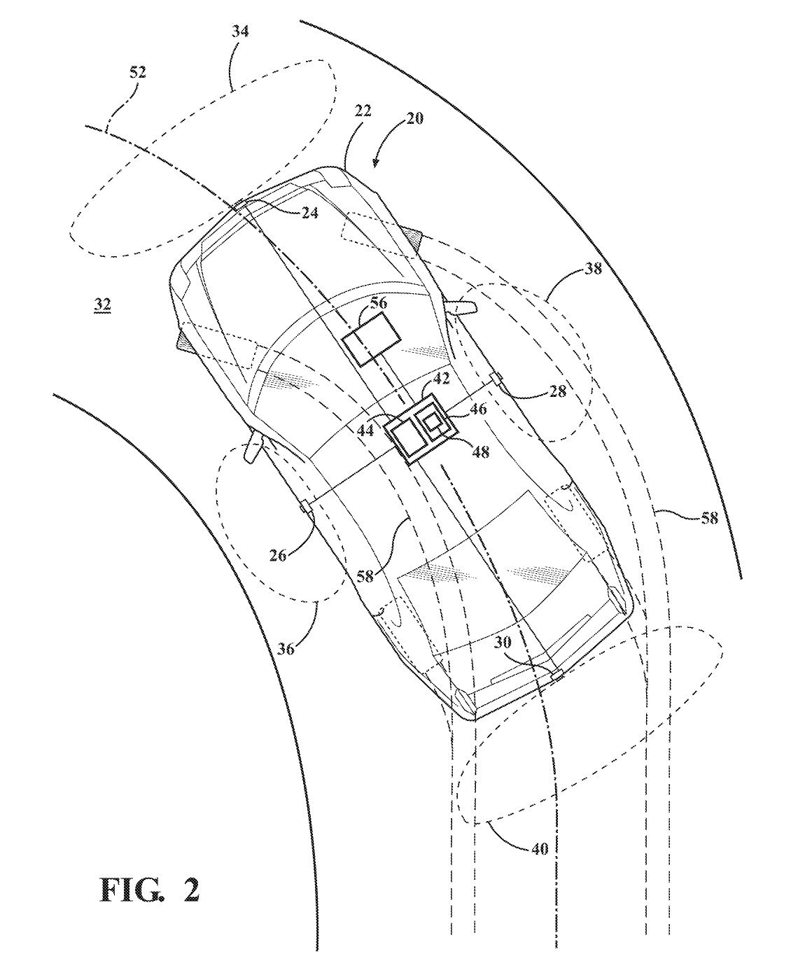

Referring to FIG. 2, when the vehicle 20 is traveling along a curved path to the left side 52 of the vehicle 20, tire tracks 58 from the front wheels may be visible in the right side image, but may not be visible in the left side image. Referring to FIG. 4, when the computing unit 42 determines that the vehicle 20 is traveling along the curved path to the left side 52 of the vehicle 20, generally indicated at 120, then analyzing the rearward image and at least one of the left side image and the right side image may include analyzing the rearward image and the right side image, to detect a tire track 58 in the rearward image and/or the right side image. The step of analyzing the rearward image and the right side image is generally indicated by box 122 in FIG. 4.

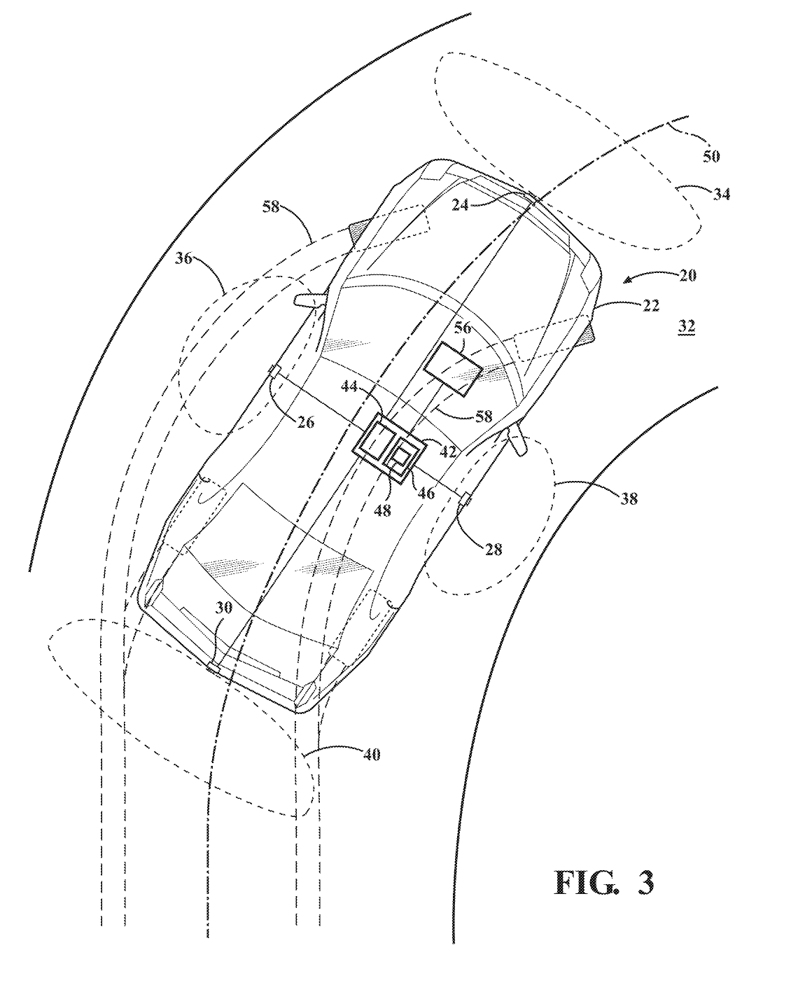

Similarly, referring to FIG. 3, when the vehicle 20 is traveling along a curved path to the right side 54 of the vehicle 20, tire tracks 58 from the front wheels may be visible in the left side image, but may not be visible in the right side image. Referring to FIG. 4, when the computing unit 42 determines that the vehicle 20 is traveling along the curved path to the right side 54 of the vehicle 20, generally indicated at 124, then analyzing the rearward image and at least one of the left side image and the right side image may include analyzing the rearward image and the left side image, to detect a tire track 58 in the rearward image and/or the left side image. The step of analyzing the rearward image and the left side image is generally indicated by box 126 in FIG. 4.

Referring to FIG. 4, when the computing unit 42 fails to detect a tire track 58 in the rearward image, generally indicated at 128, the left side image, generally indicated at 130, or the right side image, generally indicated at 132, then the computing unit 42 may determine that the road surface 32 is not covered with snow, and take no additional action, generally indicated by box 134 in FIG. 4. In alternative methods, the computing unit 42 may communicate the road condition, i.e., not covered with snow, to one or more other vehicle 20 control systems 56 so that the vehicle 20 control systems 56 may control the vehicle 20 accordingly.

When the computing unit 42 does detect a tire track 58 in one of the rearward image, generally indicated at 136, the left side image, generally indicated at 138, or the right side image, generally indicated at 140, after failing to detect a tire track 58 in the forward image, then the computing unit 42 may determine that the vehicle 20 is traveling on un-trampled snow, and that the vehicle 20 is leaving or creating tire tracks 58 in the snow on the road surface 32. Accordingly, when the computing unit 42 detects a tire track 58 in one of the rearward image, the left side image and/or the right side image, the computing unit 42 may then signal a message indicating the road surface 32 may be covered with snow. The step of signaling the message is generally indicated by box 142 in FIG. 4. The computing unit 42 may signal the message in a desirable manner. For example, the computing unit 42 may display a message to a driver, set a warning code in a vehicle 20 controller, flash an indicator lamp, communicate the message to another vehicle 20 control system 56 such as a stability control system 56, etc. The specific manner in which the message is communicated may vary, and may be dependent upon the specific application.

The computing unit 42 may communicate the identified condition of the road surface 32, i.e., covered in snow or not covered in snow, to one or more control systems 56 of the vehicle 20, so that those control systems 56 may control the vehicle 20 in a manner appropriate for the current condition of the road surface 32 identified by the computing unit 42. The step of communicating the condition of the road surface 32 to the control system 56 is generally indicated by box 144 in FIG. 4. The control system 56 may then control the vehicle 20 based on the identified condition of the road surface 32. The step of controlling vehicle 20 is generally indicated by box 146 in FIG. 4. For example, if the computing unit 42 determines that the road surface 32 is covered with snow, then the control system 56, such as but not limited to a vehicle 20 stability control system 56, may control braking of the vehicle 20 in a manner suitable for snow covered roads.

As noted above, the different images may be analyzed to detect a tire track 58 therein using a suitable algorithm, program, application, etc. For example, as noted above, the computing unit 42 may use, but is not limited to, a Canny Filter or Hough Transform to detect a line or edge, which may be used to identify a tire track 58 in the images. Other processes and/or applications may be used to detect a tire track 58 in the image. The process described below is particularly useful for images that show a trampled or driven upon, snow covered road surface 32.

In order to detect a tire track 58 on a trampled, snow covered road surface 32, upon which many vehicles have previously driven, the computing unit 42 analyzes the respective image, e.g., the forward image, the rearward image, the left side image and/or the right side image, using a combination of techniques, and then examines the results of each technique to make the determination of whether the road is covered with snow or not. For example, the computing unit 42 may use an edge or line analysis to detect one or more lines/edges, and/or a line pattern in the respective image. The line analysis may use a larger, global scale of the image in order to detect the lines/edges and/or line patterns. The line analysis may include, but is not limited to Leung-Malik (LM) Bank Filter, a Hough transform, Canny filter, or other similar edge analysis application. The computing unit 42 further analyzes the respective image using a statistical analysis to detect directional texture dependency and complexity in the respective images. The statistical analysis may use a smaller, localized portion of the image to detect the directional texture dependency and complexity in the image. The statistical analysis may include, but is not limited to, a Gray Scale Concurrence Matrix, or other similar application. Additionally, the computing unit 42 may analyze the respective images using a brightness analysis to detect light contrast or a brightness level in the respective images. A higher brightness level or brighter image is indicative of a snow-covered road surface, whereas a lower brightness level or darker image is indicative of a non-snow-covered road surface. The computing unit 42 performs each of these different analyses, and then examines the results from each analysis in order to identify a tire track 58 therein, and/or classify the road surface 32 as either snow covered, or not snow covered.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A method of identifying a snow covered road surface, the method comprising:
creating a forward image of a road surface in a forward region relative to a body of a vehicle, with a forward camera;
analyzing the forward image, with a computing unit, to detect a tire track in the forward image;
creating a rearward image of the road surface in a rearward region relative to the body of the vehicle, with a rearward camera, when a tire track is not detected in the forward image;
analyzing the rearward image, with the computing unit, to detect a tire track in the rearward image; and
signaling a message indicating the road surface may be covered with snow when a tire track is detected in the rearward image.

2. The method set forth in claim 1, further comprising creating at least one of a left side image of the road surface in a left side region relative to the body of the vehicle with a left side camera, and a right side image of the road surface in a right side region relative to the body of the vehicle with a right side camera, when a tire track is not detected in the forward image.

3. The method set forth in claim 2, further comprising analyzing at least one of the left side image and the right side image, with the computing unit, to detect a tire track in at least one of the left side image and the right side image.

4. The method set forth in claim 3, wherein analyzing at least one of the left side image and the right side image includes analyzing both the left side image and the right side image, with the computing unit, to detect a tire track in at least one of the left side image and the right side image, when the vehicle is traveling along a linear path.

5. The method set forth in claim 3, wherein analyzing at least one of the left side image and the right side image includes analyzing the left side image, with the computing unit, to detect a tire track in the left side image, when the vehicle is traveling along a curved path to the right side of the vehicle.

6. The method set forth in claim 3, wherein analyzing at least one of the left side image and the right side image includes analyzing the right side image, with the computing unit, to detect a tire track in the right side image, when the vehicle is traveling along a curved path to the left side of the vehicle.

7. The method set forth in claim 3, wherein signaling the message indicating the road surface may be covered with snow is further defined as signaling the message indicating the road surface may be covered with snow when a tire track is detected in at least one of the rearward image, the left side image, or the right side image.

8. The method set forth in claim 1, further comprising signaling a message indicating the road surface may be covered with snow when a tire track is detected in the forward image.

9. The method set forth in claim 3, wherein analyzing each of the forward image, the rearward image, the left side image, and the right side image includes extracting a respective region of interest from each of the forward image, the rearward image, the left side image, and the right side image.

10. The method set forth in claim 9, wherein the respective region of interest of each of the forward image, the rearward image, the left side image, and the right side image is dependent upon a current steering angle of the vehicle.

11. The method set forth in claim 3, wherein analyzing each respective one of the forward image, the rearward image, the left side image, and the right side image to detect a tire track therein includes a respective line analysis to detect one or more lines or a line pattern in the forward image, the rearward image, the left side image, and the right side image.

12. The method set forth in claim 3, wherein analyzing each respective one of the forward image, the rearward image, the left side image, and the right side image to detect a tire track therein includes a respective statistical analysis to detect directional texture dependency and complexity in the forward image, the rearward image, the left side image, and the right side image.

13. The method set forth in claim 3, further comprising analyzing at last one of the forward image, the rearward image, the left side image, and the right side image, with the computing unit, using a brightness analysis to detect a brightness level of the road surface.

14. A vehicle comprising:
a body;
a forward camera attached to the body and positioned to create an image of a road surface in a forward region relative to the body;
a rearward camera attached to the body and positioned to create an image of the road surface in a rearward region relative to the body;
a left side camera attached to the body and positioned to create an image of the road surface along a left side of the body;
a right side camera attached to the body and positioned to create an image of the road surface along a right side of the body;
a computing unit having a processor and a memory having a road surface snow detection algorithm saved thereon, wherein the processor is operable to execute the road surface snow detection algorithm to:
create a forward image of a road surface in the forward region with the forward camera;
analyze the forward image to detect a tire track in the forward image;
signal a message indicating the road surface may be covered with snow when a tire track is detected in the forward image;
create a rearward image of the road surface in the rearward region with the rearward camera, when a tire track is not detected in the forward image;
analyze the rearward image to detect a tire track in the rearward image; and
signal a message indicating the road surface may be covered with snow when a tire track is detected in the rearward image.

15. The vehicle set forth in claim 14, wherein the processor is operable to execute the road surface snow detection algorithm to create at least one of a left side image of the road surface in a left side region relative to the body of the vehicle with a left side camera, and a right side image of the road surface in a right side region relative to the body of the vehicle with a right side camera, when a tire track is not detected in the forward image.

16. The vehicle set forth in claim 15, wherein the processor is operable to execute the road surface snow detection algorithm to analyze at least one of the left side image and the right side image to detect a tire track in at least one of the left side image and the right side image.

17. The vehicle set forth in claim 16, wherein analyzing at least one of the left side image and the right side image includes:
analyze both the left side image and the right side image to detect a tire track in at least one of the left side image and the right side image, when the vehicle is traveling along a linear path;
analyze the left side image to detect a tire track in the left side image, when the vehicle is traveling along a curved path to the right side of the vehicle; and
analyze the right side image to detect a tire track in the right side image, when the vehicle is traveling along a curved path to the left side of the vehicle.

18. The vehicle set forth in claim 17, wherein the processor is operable to execute the road surface snow detection algorithm to signal the message indicating the road surface may be covered with snow when a tire track is detected in at least one of the forward image, the rearward image, the left side image, or the right side image.

19. The vehicle set forth in claim 16, wherein analyzing each of the forward image, the rearward image, the left side image, and the right side image includes extracting a respective region of interest from each of the forward image, the rearward image, the left side image, and the right side image, wherein the respective region of interest of each of the forward image, the rearward image, the left side image, and the right side image is dependent upon a current steering angle of the vehicle.

20. A method of identifying a snow covered road surface, the method comprising:
creating an image of a road surface, with a camera;
analyzing the image, with a computing unit using a line analysis algorithm, to detect a line or a line pattern in the image;
analyzing the image, with the computing unit using a statistical analysis algorithm, to detect directional texture dependency and complexity in the image;
analyzing the image, with the computing unit using a brightness analyses algorithm, to detect contrast in the image; and
examining the results of the line analysis, the statistical analysis, and the brightness analysis, with the computing unit, to determine if the road surface is covered with snow or if the road surface is not covered with snow.
